(19) United States
(12) Patent Application Publication
(10) Pub. No.: US 2026/0088364 A1
(43) Pub. Date: Mar. 26, 2026

(54) LAMINATED BODY, BATTERY, AND METHOD OF MANUFACTURING LAMINATE

(71) Applicant: HONDA MOTOR CO., LTD., Tokyo (JP)

(72) Inventor: Masahiro Ohta, Wako-shi (JP)

(21) Appl. No.: 19/273,171

(22) Filed: Jul. 18, 2025

(30) Foreign Application Priority Data
Aug. 5, 2024 (JP) 2024-128695

(51) Int. Cl. H01M 10/0585; H01M 4/02; H01M 4/62; H01M 10/0525

(52) U.S. Cl. CPC H01M 10/0585; H01M 4/622; H01M 4/626; H01M 10/0525; H01M 2004/021

(57) ABSTRACT

Provided is a laminated body obtained by laminating a plurality of electrode groups each including a positive electrode, a negative electrode and an electrolyte layer, wherein secondary particles obtained by coagulating primary particles formed of an organic material being disposed between the electrode groups adjacent to each other, and when a pressure is applied to the electrode group in a thickness direction of the electrode group, the secondary particles subjected to the pressure are separated into the primary particles, a gap between the adjacent electrode groups is filled with the primary particles, and when the primary particles are subjected to the pressure and deformed between the adjacent electrode groups, stress generated in the electrode group is mitigated and absorbed.

### CROSS-REFERENCE TO RELATED APPLICATION

Priority is claimed on Japanese Patent Application No. 2024-128695, filed Aug. 5, 2024, the content of which is incorporated herein by reference.

### BACKGROUND OF THE INVENTION

### Field of the Invention

The present invention relates to a laminated body, a battery including the laminated body, and a method of manufacturing the laminated body.

### Description of Related Art

A lithium ion secondary battery includes a laminated body obtained by laminating a plurality of electrode groups each including a positive electrode, a negative electrode and an electrolyte layer. When the plurality of electrode groups are laminated, depending on geometric and dimensional tolerances of the electrode group, the laminated body may become warped (deformed). In a state in which the laminated body is warped, there are issues with this, such as it hindering the containment of the laminated body in the exterior material and reducing the charge/discharge efficiency of the laminated body. In addition, in the above-mentioned state, expansion and contraction of the laminated body due to charge/discharge can exert a pressure on the laminated body, causing the laminated body to become damaged.

For example, as a method of absorbing expansion of a negative electrode and suppressing deterioration of the electrode, there is known a separator provided with a porous base layer and a porous surface layer that is provided on at least one main surface of the base layer and that includes first particles, second particles and a resin material, wherein the surface layer includes a first region constituted by at least the first particles and a second region constituted by the second particles and the resin material (for example, see PCT International Publication No. 2013/133025).

### SUMMARY OF THE INVENTION

In PCT International Publication No. 2013/133025, it was disclosed that during slurry fabrication or battery fabrication, secondary particles did not collapse or only partially collapsed and that the secondary particles collapsed under the stress caused by the expansion of the electrodes in the battery, and thereby, the stress is absorbed. However, if secondary particles are allowed to collapse during battery fabrication, there is a problem that an absorption capacity of the stress caused by the electrode expansion, which was the original purpose, is reduced.

An aspect of the present invention is directed to providing a laminated body capable of mitigating and absorbing stress caused by a pressure applied to an electrode group during manufacture of a battery, and preventing damage and performance degradation of the battery, a battery including the laminated body, and a method of manufacturing the laminated body, contributing to stabilization of battery performance, improvement of quality management in the manufacturing process, and energy efficiency.

The present invention provides the following configurations.

[1] A laminated body obtained by laminating a plurality of electrode groups each including a positive electrode, a negative electrode and an electrolyte layer,
wherein secondary particles obtained by coagulating primary particles formed of an organic material are disposed between the electrode groups adjacent to each other, and
when a pressure is applied to the electrode group in a thickness direction of the electrode group, the secondary particles subjected to the pressure are separated into the primary particles, and a gap between the adjacent electrode groups is filled with the primary particles.

According to the aspect, the pressure applied to the electrode group is received during battery manufacturing, the secondary particles are separated into the primary particles, the primary particles are dispersed to fill the gap between the two adjacent electrode groups (in particular, entering into geometric tolerance or dimensional tolerance), the primary particles are deformed due to driving displacement deviation, temperature distribution, or stress by expansion of a negative electrode when using batteries, and thus, the stress can be mitigated and absorbed to prevent damage to the battery and a decrease in performance.

[2] The laminated body according to the above-mentioned [1], wherein an average particle diameter of the secondary particles is 50 μm or more and 2000 μm or less, and an average particle diameter of the primary particles is 0.05 μm or more and 100 μm or less.

According to the aspect, by keeping the average particle diameter of the secondary particles and the average particle diameter of the primary particles within the above-mentioned ranges, it is possible to suppress the decrease in energy density in the laminated body.

[3] The laminated body according to the above-mentioned [1], wherein the primary particles are formed of at least one selected from acrylic resin, styrene resin, urethane resin, silicone resin, melamine resin and silicone-acrylic resin.

According to the aspect, by forming primary particles from the above-mentioned materials, the primary particles can be subjected to super-elastic deformation. In addition, by forming the primary particles from the above-mentioned materials, the primary particles have flexibility, which helps to suppress damage to the laminated body.

[4] The laminated body according to the above-mentioned [1], wherein the primary particles are covered with a metal material containing at least one selected from nickel, tin, gold, silver and platinum.

According to the aspect, by covering the primary particles with the metal material, heat dissipation and thermal conductivity of the primary particles can be improved, and the temperature rise of the laminated body can be suppressed.

[5] The laminated body according to the above-mentioned [4], wherein a thickness of a covering by the metal material is 1 μm or less.

According to the aspect, by keeping the thickness of the covering below 1 μm, it is possible to prevent the primary particles from becoming too rigid with the covering, which would make it difficult for the primary particles to deform. That is, it is possible to prevent the primary particles from becoming less able to absorb a force.

[6] The laminated body according to the above-mentioned [1], wherein the secondary particles contain at least one selected from an emulsion type, a micelle type and a gemini type.

According to the aspect, by using the secondary particles of either emulsion type, micelle type or gemini type, the primary particles have an appropriate bonding strength, and the secondary particles can be separated into primary particles by applying a force.

[7] The laminated body according to the above-mentioned [1], wherein the secondary particles include a binder, and
the binder includes at least one selected from vinyl chloride resin, vinyl acetate resin, acrylic resin, silicone resin, ether resin, styrene resin, cyclohexane, toluene, and a compound having a dicarbonyl group having two hydrocarbon chains.

According to the aspect, by including the binder in the secondary particles, the secondary particles can be formed into any one of the emulsion type, the micelle type, and the gemini type.

[8] The laminated body according to the above-mentioned [1], wherein the secondary particles have an internal space formed by coagulation of the primary particles, and
the internal space contains a liquid.

According to the aspect, due to the liquid being contained in the internal space formed by coagulation of the primary particles, slipperiness of the primary particles is improved, and the primary particles resulting from the collapse of the secondary particles between the adjacent electrode groups are more easily dispersed.

[9] The laminated body according to the above-mentioned [8], wherein the liquid contains at least one of cyclohexane and toluene.

According to the aspect, by using cyclohexane or toluene as the liquid, slipperiness of the primary particles is improved, and the primary particles resulting from the collapse of the secondary particles between the adjacent electrode groups are more easily dispersed.

[10] The laminated body according to the above-mentioned [1], further including a resin substrate with the secondary particles disposed on at least one main surface thereof,
wherein the resin substrate is disposed between the adjacent electrode groups.

According to the aspect, by disposing the resin substrate with the secondary particles arranged on at least one of the main surfaces between the adjacent electrode groups, it is possible to arrange and fix the secondary particles in the desired position, and further to uniformly mitigate the stress concentration of the laminated body.

[11] The laminated body according to the above-mentioned [1], wherein the electrolyte layer is a solid electrolyte layer.

According to the aspect, by making the electrolyte layer a solid electrolyte layer, it can be applied to all solid batteries.

[12] A battery comprising the laminated body according to any one of the above-mentioned [1] to [11], an exterior material that covers the laminated body, and beads disposed between the outermost layer of the laminated body and the exterior material,
wherein the beads are constituted by the primary particles.

According to the aspect, by disposing the primary particles between the outermost layer of the laminated body and the exterior material, the primary particles can absorb the dimensional tolerance and the geometric tolerance of the electrode group and suppress damage to the laminated body.

[13] A method of manufacturing a laminated body obtained by laminating a plurality of electrode groups each including a positive electrode, a negative electrode and an electrolyte layer, the method having:
a first process of coagulating primary particles formed of an organic material and fabricating secondary particles;
a second process of disposing the secondary particles between the electrode groups adjacent to each other;
a third process of applying a pressure to the electrode group in a thickness direction of the electrode group, separating the secondary particles into the primary particles, and filling a gap between the adjacent electrode groups with the primary particles; and
a fourth process of deforming the primary particles between the adjacent electrode groups by the pressure and absorbing stress generated in the electrode group.

According to the aspect, the laminated body of the present invention is obtained.

[14] The method of manufacturing a laminated body according to the above-mentioned [13], further including a fifth process of applying the secondary particles obtained in the first process to at least one main surface of a resin substrate, before the second process.

According to the aspect, the laminated body of the present invention is obtained.

According to the aspect of the present invention, it is possible to provide a laminated body capable of mitigating and absorbing stress caused by a pressure applied to an electrode group during manufacture of a battery, and preventing damage and performance degradation of the battery, a battery including the laminated body, and a method of manufacturing the laminated body.

### BRIEF DESCRIPTION OF THE DRAWINGS

FIG. 1 is a cross-sectional view showing a laminated body according to an embodiment of the present invention.

FIG. 2 is a partially enlarged view of FIG. 1.

FIG. 3 is a view showing actions of secondary particles and primary particles.

FIG. 4 is a view showing actions of the secondary particles and the primary particles.

FIG. 5 is a view showing actions of the secondary particles and the primary particles.

FIG. 6 is a view showing actions of the secondary particles and the primary particles.

FIG. 7 is a cross-sectional view showing a method of manufacturing the laminated body according to the embodiment of the present invention.

FIG. 8 is a cross-sectional view showing the method of manufacturing the laminated body according to the embodiment of the present invention.

FIG. 9 is a cross-sectional view showing the method of manufacturing the laminated body according to the embodiment of the present invention.

FIG. 10 is a cross-sectional view showing the method of manufacturing the laminated body according to the embodiment of the present invention.

FIG. 11 is a partially enlarged view of FIG. 1.

FIG. 12 is a cross-sectional view showing the method of manufacturing the laminated body according to the embodiment of the present invention.

FIG. 13 is a cross-sectional view showing the method of manufacturing the laminated body according to the embodiment of the present invention.

FIG. 14 is a cross-sectional view showing the method of manufacturing the laminated body according to the embodiment of the present invention.

FIG. 15 is a cross-sectional view showing a battery according to the embodiment of the present invention.

### DETAILED DESCRIPTION OF THE INVENTION

Hereinafter, an embodiment of the present invention will be described in detail with reference to the accompanying drawings.

### First Embodiment

### [Laminated Body]

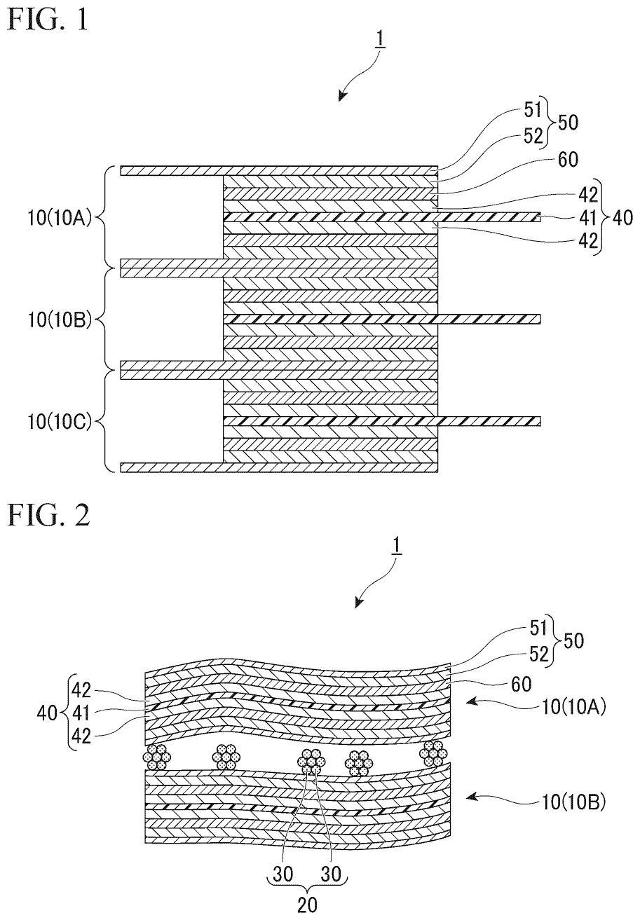

A laminated body according to a first embodiment of the present invention will be described with reference to FIG. 1 and FIG. 2.

FIG. 1 is a cross-sectional view showing a laminated body according to the embodiment of the present invention. FIG. 2 is a partially enlarged view of FIG. 1. Further, the drawings used in the following description may show characteristic parts enlarged for convenience in order to make the characteristics easier to understand, and the dimensional ratios of each component are not limited to those illustrated.

As shown in FIG. 1, a laminated body 1 of the embodiment is a laminated body in which three electrode groups 10 (10A, 10B, 10C) are laminated. As shown in FIG. 2, secondary particles 20 are disposed between the electrode group 10A and the electrode group 10B, which are adjacent to each other. The secondary particles 20 are particles in which primary particles 30 are coagulated. Further, in the laminated body 1 of the embodiment, the secondary particles 20 are also disposed between the electrode group 10B and the electrode group 10C, which are adjacent to each other.

The electrode group 10 is constituted by a positive electrode 40, a negative electrode 50 and an electrolyte layer 60.

The positive electrode 40 and the negative electrode 50 are alternately laminated via the electrolyte layer 60. In the embodiment, lamination is performed in sequence of the negative electrode 50/the electrolyte layer 60/the positive electrode 40/the electrolyte layer 60/the negative electrode 50. The charging and discharging of the laminated body 1 is performed by the exchange of lithium ions between the positive electrode 40 and the negative electrode 50 through the electrolyte layer 60.

### (Positive Electrode)

The positive electrode 40 is obtained by laminating a positive electrode current collector 41, and positive electrode active material layers 42 that contains at least a positive electrode active material. In the embodiment, the positive electrode 40 has the positive electrode current collector 41, and the positive electrode active material layers 42 formed on both main surfaces of the positive electrode current collector 41.

The positive electrode current collector 41 is preferably formed of at least one material having high conductivity. As the material having high conductivity, for example, metals or alloys containing at least one of metal elements such as silver (Ag), palladium (Pd), gold (Au), platinum (Pt), aluminum (Al), chromium (Cr), and nickel (Ni), or non-metals such as carbon (C) are included. Considering the manufacturing cost as well as high conductivity, aluminum, nickel or stainless steel is preferred. Further, aluminum does not easily react with the positive electrode active material and the electrolyte. For this reason, if aluminum is used for the positive electrode current collector 41, the internal resistance of the battery can be reduced.

The shape of the positive electrode current collector 41 can be, for example, a foil form, a plate shape, a mesh shape, a non-woven shape, a fabric form, a foam shape, or the like. In addition, in order to enhance adhesion with the positive electrode active material layers 42, carbon or the like may be disposed on the surface of the positive electrode current collector 41, or the surface may be roughened.

The positive electrode active material layer 42 includes a positive electrode active material that exchanges lithium ions and electrons. There are no particular limitations on the positive electrode active material, as long as it can reversibly release and absorb lithium ions and is capable of electron transportation, and any known positive electrode active material that can be used for a positive electrode of a lithium ion battery can be used. For example, complex oxides such as lithium cobalt oxide (LiCoO₂), lithium nickel oxide (LiNiO₂), lithium manganese oxide (LiMn₂O₄), solid solution oxides (Li₂MnO₃—LiMO₂ (M=Co, Ni, or the like)), lithium-manganese-nickel-cobalt oxide (LiNiₓMn_{y}Co_{z}O₂, x+y+z=1), olivine-type lithium phosphate (LiFePO₄), or the like; conductive polymers such as polyaniline, polypyrrole, or the like; sulfides such as Li₂S, CuS, Li—Cu—S compound, TiS₂, FeS, MoS₂, Li—Mo—S compounds, or the like; a mixture of sulfur and carbon, or the like, is exemplified. The positive electrode active material may be composed of one of the above-mentioned materials alone or two or more of them.

The positive electrode active material layers 42 contains an electrolyte that exchanges the positive electrode active material and lithium ions. There are no particular limitations on the electrolyte as long as it has lithium ion conductivity, and any material generally used for lithium ion batteries can be used. Examples of the electrolytes include inorganic solid electrolytes such as sulfide solid electrolyte materials, oxide solid electrolyte material, halide solid electrolyte, lithium-containing salts, or the like, polymer-based solid electrolytes such as polyethylene oxide or the like, and gel-based solid electrolytes containing lithium-containing salts or ionic liquids with lithium ion conductivity, or the like. Among these, sulfide solid electrolyte materials are preferred from the viewpoints of the high conductive properties of lithium ions, as well as favorable structural formability or interface bonding by pressing.

The electrolyte may be composed of one of the above-mentioned materials alone, or may be composed of two or more of them. The electrolyte contained in the positive electrode active material layers 42 may be the same material as the electrolyte contained in a negative electrode active material layer 52 and the electrolyte layer, or it may be a different material.

The positive electrode active material layers 42 may contain a conductive additive in order to improve the conductivity of the positive electrode 40. As for the conductive additive, conductive additives that can generally be used in lithium ion batteries can be used. Examples include carbon black such as acetylene black and Ketjen black; carbon fiber; vapor grown carbon fiber; graphite powder; and carbon materials such as carbon nano tubes. The conductive additive may consist of one of the above-mentioned materials alone, or two or more of them.

In addition, the positive electrode active material layers 42 may contain the positive electrode active materials and a binder that serves to bind the positive electrode active materials and the positive electrode current collector 41.

In the embodiment, while the positive electrode active material layers 42 are formed on both main surfaces of the positive electrode current collector 41, this is not limited thereto, and the positive electrode active material layers 42 may be formed on only one main surface of the positive electrode current collector 41. In addition, when the positive electrode 40 is a single-sided coated electrode, a laminated positive electrode with the current collector surfaces of two positive electrodes aligned may be used as a double-sided coated electrode. In addition, when the positive electrode current collector 41 is a three-dimensional porous structure such as a mesh shape, a non-woven shape, a foam shape, or the like, the positive electrode current collector 41 may be integrally formed with the positive electrode active material layers 42.

### (Negative Electrode)

The negative electrode 50 is constituted by a negative electrode current collector 51 and the negative electrode active material layer 52 which contains at least a negative electrode active material. In the embodiment, the negative electrode 50 has the negative electrode current collector 51, and the negative electrode active material layer 52 formed on one main surface of the negative electrode current collector 51 and containing a negative electrode active material and electrolyte.

The negative electrode current collector 51 contains at least copper (Cu). The negative electrode current collector 51, like the positive electrode current collector 41, may contain a material other than copper having high conductivity. Materials other than copper having high conductivity include, for example, metals or alloys that contain at least one of the metallic elements such as silver (Ag), palladium (Pd), gold (Au), platinum (Pt), chromium (Cr) and nickel (Ni), or non-metals such as carbon (C). Considering the manufacturing cost as well as the conductivity height, nickel or stainless steel is preferable as a material other than copper. Further, stainless steel does not react easily with the positive electrode active material, the negative electrode active material and the electrolyte. For this reason, using stainless steel for the negative electrode current collector 51 can reduce the manufacturing cost of the battery.

The shape of the negative electrode current collector 51 can be, for example, a foil shape, a plate shape, a mesh shape, a non-woven shape, a foam shape, or the like. In addition, in order to improve adhesion with the negative electrode active material layer 52, carbon or the like may be disposed on the surface of the negative electrode current collector 51, or the surface may be roughened.

The negative electrode active material layer 52 contains a negative electrode active material that exchanges lithium ions and electrons. There are no particular limitations on the negative electrode active material, as long as it can reversibly release and absorb lithium ions and is suitable for electron transportation, and any known negative electrode active material that can be used for the negative electrode of the lithium ion battery can be used. Examples of the material may include a carbonaceous material such as natural graphite, artificial graphite, resin charcoal, carbon fiber, activated charcoal, hard carbon, soft carbon, or the like, alloy materials mainly consisting of tin, tin alloy, silicon, silicon alloy, gallium, gallium alloy, indium, indium alloy, aluminum, aluminum alloy, or the like; conductive polymer such as polyacene, polyacetylene, polypyrrole, or the like; metal lithium; lithium titanium complex oxide (for example, Li₄Ti₅O₁₂), or the like. These negative electrode active materials may be composed of one of the above materials alone or two or more of them.

The negative electrode active material layer 52 contains an electrolyte that exchanges the negative electrode active material and lithium ions. There are no particular limitations on the electrolyte as long as it has lithium ion conductivity, and any material generally used for lithium ion batteries can be used. Examples of the electrolyte may include an inorganic solid electrolyte such as a sulfide solid electrolyte material, an oxide solid electrolyte material, a halide solid electrolyte, lithium-containing salts, or the like, a polymer-based solid electrolyte such as polyethylene oxide or the like, or a gel-based solid electrolyte containing lithium-containing salts or ion liquid having lithium ion conductivity. The electrolyte may be composed of one of the above-mentioned materials alone, or may be composed of two or more of them. The electrolyte contained in the negative electrode active material layers 52 may be the same as or different from the electrolyte contained in the positive electrode active material layers 42 or the electrolyte layers.

The negative electrode active material layer 52 may contain conductive additives and binders. There are no particular limitations on these materials, but for example, materials similar to those used for the positive electrode active material layers 42 described above can be used.

In this embodiment, while the negative electrode active material layer 52 is formed on only one main surface of the negative electrode current collector 51, this is not limited to this, and the negative electrode active material layer 52 may be formed on both main surfaces of the negative electrode current collector 51. In addition, when the negative electrode current collector 51 is a three-dimensional porous structure such as a mesh shape, a non-woven shape, a foam shape, or the like, the negative electrode current collector 51 may be integrally formed with the negative electrode active material layer 52.

### (Electrolyte Layer)

The electrolyte layer 60 is disposed between the positive electrode active material layers 42 and the negative electrode active material layer 52. Then, in the direction perpendicular to the laminating direction, the area of the electrolyte layer 60 is greater than the area of the positive electrode active material layers 42 on the positive electrode 40. Accordingly, it is possible to suppress lithium electrodeposition in the electrode outer circumferential portion.

There are no particular limitations on the electrolyte as long as it has lithium ion conductivity and insulation, and any material generally used for lithium ion batteries can be used. Examples of the material may include an inorganic solid electrolyte such as a sulfide solid electrolyte material, an oxide solid electrolyte material, a halide solid electrolyte, lithium-containing salts, or the like, a polymer-based solid electrolyte such as polyethylene oxide or the like, a gel-based electrolyte containing lithium-containing salts or ion liquid of lithium ion conductivity, or the like. Among these, the sulfide solid electrolyte material is preferable because of the high conductive properties of lithium ions, as well as favorable structural formability and interface bonding when pressed.

The form of the electrolyte material is not particularly limited, but may be, for example, in the form of particles. When the electrolyte layer 60 is a solid electrolyte layer, the laminated body 1 is constructed entirely of a solid material, and for example, when the laminated body 1 is accommodated within a can body, the laminated body 1 can support itself inside the can body.

The electrolyte layer 60 may contain an adhesive agent to impart mechanical strength or flexibility.

The electrolyte layer 60 may be in the form of a sheet having a porous substrate and a solid electrolyte supported on the porous substrate. The form of the porous substrate is not particularly limited, but examples include woven fabric, non-woven fabric, mesh cloth, porous film, expanded sheet, punching sheet, or the like. Among these forms, non-woven fabrics are preferred from the viewpoint of handling, which allows a larger filling volume of the solid electrolyte.

The porous substrate is preferably composed of an insulating material. Accordingly, it is possible to improve insulation of the electrolyte layer 60. Examples of the insulating material may include a resin material such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, acrylic resin, or the like; natural fibers such as hemp, wood pulp, cotton linters, or the like; glass, or the like

### (Primary Particles)

The primary particles 30 are the particles that constitute the secondary particles 20.

An average particle diameter of the primary particles 30 is preferably 0.05 μm or more and 100 μm or less. By keeping the average particle diameter of the primary particles 30 within the range, the decrease in energy density in the laminated body 1 can be suppressed. When the average particle diameter of the primary particles 30 is less than the lower limit value, the primary particles 30 are too small and have little effect on absorbing the geometric tolerance. When the average particle diameter of the primary particles 30 exceeds the upper limit value, the adsorption power of the binder becomes too high, making it difficult for the primary particles 30 to collapse, leading to a decrease in the energy density in the laminated body 1.

The materials that constitute the primary particles 30 are preferably acrylic resin, styrene resin, urethane resin, silicone resin, melamine resin, or silicone-acrylic resin. The primary particles 30 may be composed of one type of the above-mentioned materials alone, or may be composed of two or more types. By forming the primary particles 30 from the above-mentioned materials, the primary particles 30 can be subjected to super-elastic deformation. In addition, by forming the primary particles 30 from the above-mentioned material, the primary particles 30 have flexibility, which makes it possible to suppress damage to the laminated body.

The primary particles 30 are preferably covered with a metal material. The metal material is preferably nickel, tin, gold, silver, platinum, or the like. The metal material may be composed of one of the above-mentioned materials alone, or may be composed of two or more of them. By covering the primary particles 30 with the metal material, the heat dissipation and thermal conductivity of the primary particles 30 can be improved, and the temperature rise of the laminated body 1 can be suppressed. Further, when copper is used as the negative electrode current collector 51, no material that is subject to electrochemical corrosion should be used as the metal material.

The thickness of the covering by the metal material in the primary particles 30 is preferably 1 μm or less, more preferably 0.8 μm or less, and even more preferably 0.5 μm or less. In addition, the lower limit value of the thickness of the covering is preferably 0.01 μm or more, more preferably 0.02 μm or more, and even more preferably 0.05 μm or more. When the thickness of the covering is equal to or smaller than the upper limit value, it is possible to prevent the primary particles 30 from becoming too rigid with the covering, which would make it difficult for the primary particles 30 to deform. That is, it is possible to prevent the primary particles 30 from becoming less able to absorb a force. When the thickness of the covering is equal to or greater than the lower limit value, the organic matter holding surface can be covered uniformly, and the thermal conductivity can be improved.

### (Secondary Particles)

The secondary particles 20 are particles formed by coagulation of the primary particles 30.

The average particle diameter of the secondary particles 20 is preferably 50 μm or more and 2000 μm or less. By setting the average particle diameter of the secondary particles 20 within this range, the decrease in energy density in the laminated body 1 can be suppressed. When the average particle diameter of the secondary particles 20 is less than the lower limit value, the secondary particles 20 are too small and have little effect on absorbing the geometric tolerance. When the average particle diameter of the secondary particles 20 exceeds the upper limit value, the adsorption power of the binder becomes too high, making it difficult for the secondary particles 20 to collapse, leading to a decrease in the energy density in the laminated body 1.

The number of the primary particles 30 that constitute the secondary particles should be adjusted appropriately so that the average particle diameter of the secondary particles 20 falls within the above range. In addition, it is sufficient that the secondary particles 20 collapse by applying the pressure, and even if the average particle diameter is large, the secondary particles 20 can split and disperse if the pressure exceeds the adsorption power of the binder, so the average particle diameter of the secondary particles 20 can be 2000 μm.

The secondary particles 20 are not particularly limited, but preferably include at least one type selected from the group consisting of the emulsion type, the micelle type and the gemini type.

In the emulsion type, micelle type and gemini type, the primary particles 30 have an appropriate bonding strength, and the secondary particles 20 easily separate into the primary particles 30 when subjected to the force.

The secondary particles 20 preferably contain a binder for coagulation (bonding) with the primary particles 30. Preferred binders are vinyl chloride resin, vinyl acetate resin, acrylic resin, silicone resin, ether resin, styrene resin, cyclohexane, toluene, and compounds having a dicarbonyl group with two hydrocarbon chains. The binder may be composed of one of the above-mentioned materials alone, or may be composed of two or more of them. By including these resins or compounds as binders in the secondary particles 20, the secondary particles 20 can be formed into any one of the emulsion type, the micelle type and the gemini type.

It is preferred that the secondary particles 20 have an internal space formed by coagulation of the primary particles 30, and the internal space contains liquid. For example, it is preferred that the primary particles 30 have a spherical shell with an internal space that contains liquid. The secondary particles 20 contain liquid, which improves slipperiness of the primary particles 30 and makes it easier for the primary particles 30 to disperse when the secondary particles 20 collapse between two electrode groups 10 (for example, between electrode group 10B and electrode group 10C).

The liquid is not particularly limited, but preferably contains at least one of cyclohexane and toluene. When the liquid contains at least one of cyclohexane and toluene, the slipperiness of the primary particles 30 is improved compared to when other liquids are contained, and the primary particles 30 resulting from the collapse of the secondary particles 20 between two electrode groups 10 (for example, between the electrode group 10B and the electrode group 10C) become easier to disperse.

In a cross-section of the electrode group 10 in the thickness direction, the area (occupied area) occupied by the secondary particles 20 between the two adjacent electrode groups 10 is not particularly limited, but for example, the area of the secondary particles 20 spread out between the two adjacent electrode groups 10 is preferably 60% or more and 90% or less of the cross-sectional area of the electrode group in the thickness direction. If the area is less than 60%, a stress distribution will be significantly different between the areas where the secondary particles 20 are present and those where the secondary particles 20 are not present, and the effect of making the pressure uniform will be reduced. If the area exceeds 90%, when the secondary particles 20 are decomposed into the primary particles 30 and spread between the electrode groups 10, the friction between the primary particles 30 makes it difficult for the primary particles 30 to diffuse, and it becomes difficult for the primary particles 30 to exist uniformly.

### (Action of Secondary Particles and Primary Particles)

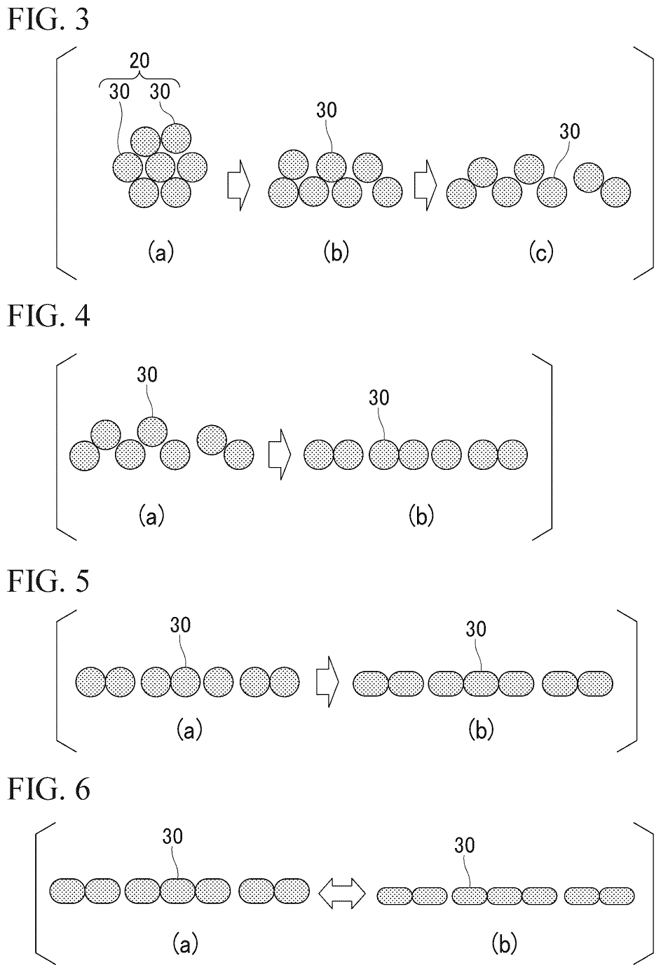

Here, actions of the secondary particles 20 and the primary particles 30 will be described with reference to FIG. 3 to FIG. 6. For example, when the plurality of electrode groups 10 are laminated to form the laminated body 1, if the pressure is applied to the plurality of electrode groups 10 in the thickness direction of the electrode group 10, the secondary particles 20 subjected to the pressure will separate (collapse) into the primary particles 30, and the separated primary particles 30 will be dispersed between two adjacent electrode groups 10, as shown in FIG. 3. Accordingly, the primary particles 30 absorb the geometric tolerance of the two adjacent electrode groups 10.

In addition, for example, when applying the pressure to the laminated body 1 in the thickness direction of the laminated body 1 while covering the laminated body 1 with an exterior material, the collapsed secondary particles 20 slide between the two adjacent electrode groups 10 and disperse, as shown in FIG. 4. By collapsing the secondary particles 20 between the two adjacent electrode groups 10 and dispersing the primary particles 30 between the two adjacent electrode groups 10, the pressure throughout the laminated body 1 can be made nearly uniform.

When the pressure (external force) is applied to the laminated body 1 in the thickness direction of the laminated body 1, the primary particles 30 undergo super-elastic deformation as shown in FIG. 5, and the primary particles 30 absorb the pressure, making the pressure across the entire laminated body 1 almost uniform.

When further the pressure (external force) is applied to the laminated body 1 in the thickness direction of the laminated body when the laminated body 1 is accommodated in an exterior material, when further the pressure (external force) is applied to the laminated body 1 in the thickness direction of the laminated body 1 when the laminated body accommodated in the exterior material is further assembled as a battery module, or when the laminated body 1 expands or contracts due to charge/discharge, the primary particles 30 undergo super-elastic deformation, as shown in FIG. 6, and the primary particles 30 absorb the pressure. Accordingly, the pressure across the entire laminated body 1 can be made almost uniform.

According to the laminated body 1 of the embodiment, when the pressure is applied to the electrode group 10 during battery manufacturing, the secondary particles separate into the primary particles 30, and the primary particles 30 disperse to fill the gaps between the two adjacent electrode groups (especially into the geometric tolerance or dimensional tolerance), and when the battery is in use, the primary particles 30 deform in response to stress caused by driving displacement deviation, temperature distribution, or expansion of the negative electrode, thereby mitigating and absorbing the stress and preventing damage to the battery and degradation of the performance.

### [Method of Manufacturing Laminated Body]

A method of manufacturing a laminated body according to the first embodiment of the present invention is the method of manufacturing the laminated body of the first embodiment described above, having a first process of coagulating primary particles formed of an organic material and fabricating secondary particles, a second process of disposing the secondary particles between electrode groups adjacent to each other, a third process of applying a pressure to the electrode group in a thickness direction of the electrode group, separating the secondary particles into the primary particles and filling a gap between the adjacent electrode groups with the primary particles, and a fourth process of deforming the primary particles between the adjacent electrode groups by the pressure and absorbing stress generated in the electrode groups.

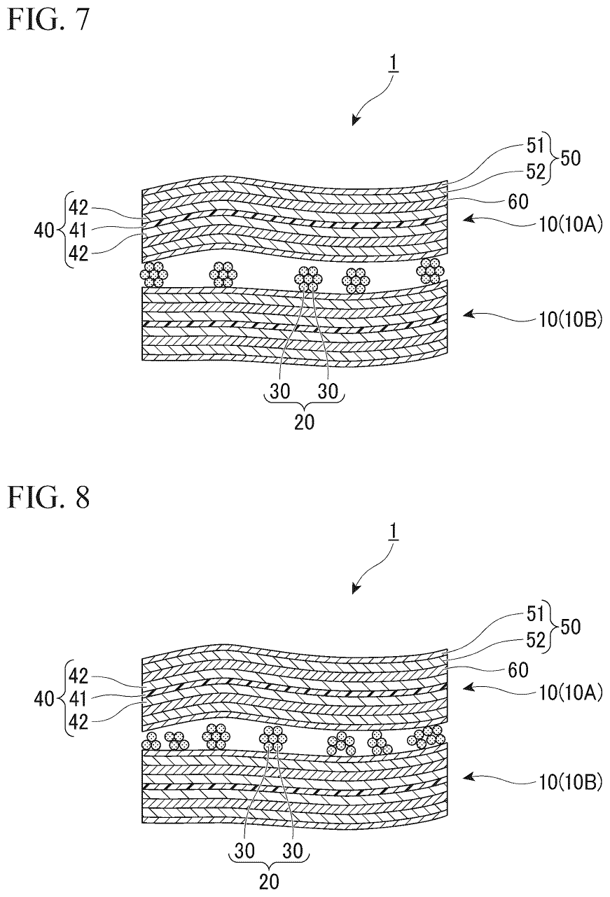

The method of manufacturing the laminated body of the embodiment will be described with reference to FIG. 7 to FIG. 10.

### (First Process)

In the first process, the primary particles formed of an organic material are coagulated to fabricate the secondary particles.

The primary particles and a binder are dispersed in solvent to prepare a colloidal solution containing a colloid of the primary particles.

As the primary particles, those mentioned in the laminated body of the embodiment above can be used.

As the binder, the same as in the laminated body of the embodiment mentioned above can be used. The solvents that can be used include water, methanol, ethanol, alcohol such as isopropyl alcohol or the like, and mixed solvents made by mixing these solvents.

The solid concentration in the colloidal solution is preferably 5 mass % or more and 50 mass % or less, more preferably 10 mass % or more and 40 mass % or less, and even more preferably 20 mass % or more and 35 mass % or less, based on the total mass of the colloidal solution. When the solid concentration is equal to or greater than the lower limit value, the secondary particles are obtained.

A mass ratio of the primary particles and the binder, in other words, a mass ratio of the binder with respect to the primary particles (binder/primary particles×100(%)) is preferably 0.5% or more and 15% or less, more preferably 1% or more and 10% or less, and even more preferably 2% or more and 5% or less. When the mass ratio is equal to or greater than the lower limit value, it is possible to provide moderate bonding strength. When the mass ratio is equal to or smaller than the upper limit value, it is possible to separate the secondary particles with moderate stress.

The resulting colloidal solution is dried by a spray drying method, and the primary particles are coagulated to obtain the secondary particles. Further, a drying temperature is equal to or greater than 80% of a solvent boiling point.

### (Second Process)

In the second process, as shown in FIG. 7, the plurality of electrode groups 10 are laminated, and the secondary particles 20 obtained in the first process are disposed between the two adjacent electrode groups 10.

Methods of disposing the secondary particles 20 between the two adjacent electrode groups 10 include, for example, a method of applying a slurry containing the secondary particles 20 between the two electrode groups 10, a method of spraying the secondary particles 20 between the two electrode groups 10, and the like.

The amount of the secondary particles 20 arranged in the cross-section of the electrode group 10 in the thickness direction is not particularly limited, but for example, the area in which the secondary particles 20 spread between the two adjacent electrode groups 10 is preferably 60% or more and 90% or less of the cross-sectional area of the electrode group 10 in the thickness direction. If the area is less than 60%, the stress distribution will be significantly different between the areas where the secondary particles 20 are present and those where the secondary particles 20 are not present, and the effect of making the pressure uniform will be reduced. If the area exceeds 90%, when the secondary particles 20 decompose into the primary particles 30 and spread between the electrode groups 10, friction between the primary particles 30 makes it difficult for diffusion to occur, making it difficult for the primary particles 30 to exist uniformly.

### (Third Process)

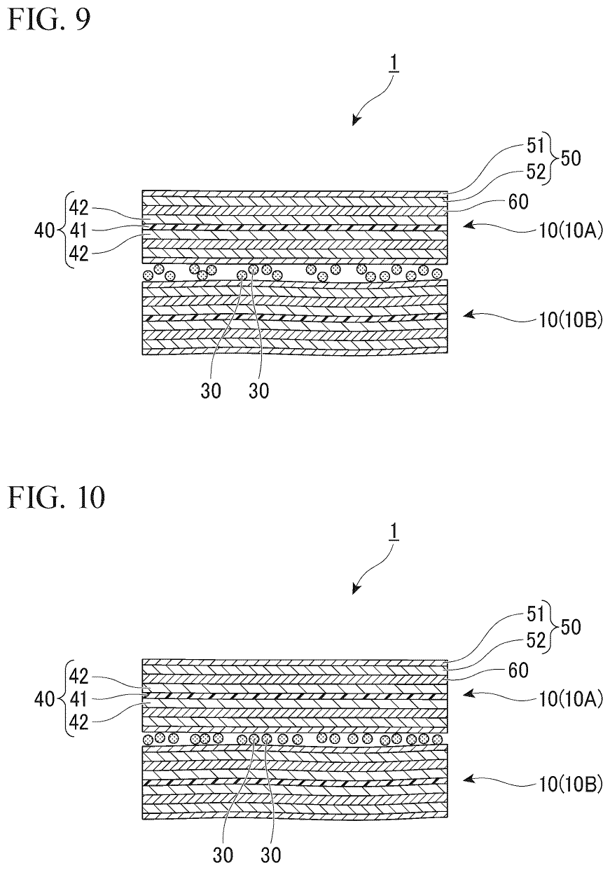

In the third process, as shown in FIG. 8 and FIG. 9, the pressure is applied to the plurality of electrode groups 10 in the thickness direction of the electrode groups 10 to separate the secondary particles 20 into the primary particles 30, and the gap between the two adjacent electrode groups 10 is filled with the primary particles 30. When the pressure is applied to the plurality of electrode groups 10 in the thickness direction of the electrode group 10, as shown in FIG. 8 and FIG. 9, the secondary particles 20 subjected to the pressure separate (collapse) into the primary particles 30, and the gap between the two adjacent electrode groups 10 is filled with the separated primary particles 30, and the primary particles 30 are dispersed between the two adjacent electrode groups 10. Accordingly, the primary particles 30 absorb the geometric tolerance of the two adjacent electrode groups 10.

The magnitude of the pressure applied to the electrode group 10 in the thickness direction is not particularly limited, but for example, it is preferably 0.1 MPa or more and MPa or less, more preferably 0.8 MPa or more and 5 MPa or less, and even more preferably 1 MPa or more to 3 MPa or less. When the magnitude of the pressure is equal to or greater than the lower limit value, the primary particles 30 separated from the secondary particles 20 can be uniformly dispersed between the electrode groups 10. When the magnitude of the pressure is equal to or greater than the upper limit value, it is possible to suppress damage to the electrode group 10.

### (Fourth Process)

In the fourth process, as shown in FIG. 10, further, the pressure is applied to the plurality of electrode groups 10 in the thickness direction of the electrode groups 10, causing the primary particles 30 to deform between two adjacent electrode groups 10, thereby absorbing the stress generated in the electrode groups 10.

The fourth process includes applying further the pressure (external force) in the thickness direction of the laminated body 1 when the laminated body 1 is accommodated in exterior material, applying further the pressure (external force) in the thickness direction of the laminated body 1 when the laminated body accommodated in the exterior material is further assembled into a battery module, or expanding or contracting the laminated body 1 by charge/discharge. Accordingly, the primary particles 30 undergo super-elastic deformation, and the primary particles 30 absorb the pressure, making the pressure across the entire laminated body 1 almost uniform.

According to the method of manufacturing the laminated body of the embodiment, the laminated body 1 of the first embodiment described above is obtained.

### Second Embodiment

### [Laminated Body]

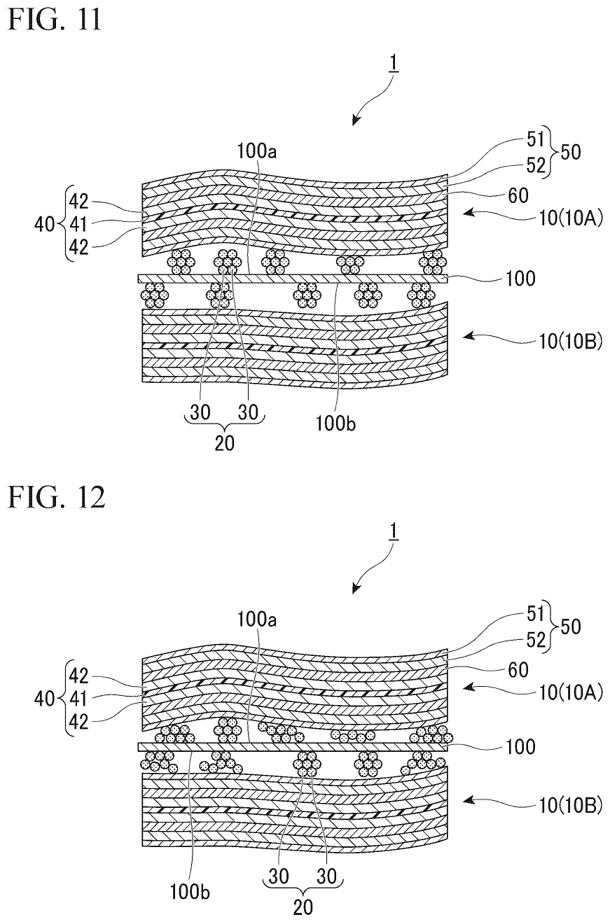

A laminated body according to a second embodiment of the present invention will be described with reference to FIG. 1 and FIG. 11.

FIG. 11 is a partially enlarged view of FIG. 1. In FIG. 11, the same components as those in FIG. 1 and FIG. 2 are designated by the same reference numerals and the description thereof will be omitted.

The laminated body 1 of the second embodiment is distinguished from the laminated body 1 of the first embodiment in that it includes a resin substrate 100 with secondary particles 20 disposed on both main surfaces 100a and 100b, and the resin substrate 100 is disposed between two adjacent electrode groups 10, as shown in FIG. 11. Further, the resin substrate 100 may have the secondary particles 20 disposed on only one main surface 100a.

An area occupied by the secondary particles 20 between the two adjacent electrode groups 10 in a cross-section in the thickness direction of the electrode groups (occupied area), i.e., the amount of the secondary particles 20 present on both of the main surfaces 100a and 100b of the resin substrate 100, is not particularly limited, but for example, it is preferable that the area of the secondary particles 20 spread between the two adjacent electrode groups 10 is 60% or more and 90% or less of the cross-sectional area in the thickness direction of the electrode groups 10. If the area is less than 60%, the stress distribution will be significantly different between the areas where the secondary particles 20 are present and those where the secondary particles 20 are not present, and the effect of making the pressure uniform will be reduced. If the area exceeds 90%, when the secondary particles 20 decompose into the primary particles 30 and spread between the electrode groups 10, the friction between the primary particles 30 makes it difficult for diffusion to occur, and it becomes difficult for the primary particles to exist uniformly.

The form of the resin substrate 100 is not particularly limited, but it is preferably in the form of a film.

Examples of the materials that form the resin substrate 100 include polyethylene terephthalate, polypropylene, polyamide-imide, and the like. The resin substrate 100 may be composed of a single type of the above-mentioned materials, or may be composed of two or more types.

The thickness of the resin substrate 100 is preferably 0.5 μm or more and 25 μm or less, more preferably 1 μm or more and 12 μm or less, and even more preferably 2 μm or more and 8 μm or less. When the thickness of the resin substrate 100 is equal to or smaller than the upper limit value, the resin substrate 100 can be easily disposed between the electrode groups 10. When the thickness of the resin substrate 100 is equal to or greater than the lower limit value, it is possible to suppress a decrease in energy density of the laminated body 1.

When the secondary particles 20 contain a binder, the binder causes the secondary particles 20 to adhere to the one main surface 100a and the other main surface 100b of the resin substrate 100. When the secondary particles 20 do not contain the binder, the binder is applied to the one main surface 100a or the other main surface 100b of the resin substrate 100, the secondary particles 20 are adhered to the one main surface 100a or the other main surface 100b of the resin substrate 100 via the binder.

As such a binder, the same one as that used for the secondary particles 20 is used.

According to the laminated body 1 of the embodiment, by disposing the resin substrate 100, with the secondary particles 20 arranged on at least one of the main surfaces, between the two adjacent electrode groups 10, it is possible to arrange and fix the secondary particles 20 in the desired position, and further to uniformly mitigate the stress concentration of the laminated body 1.

### [Method of Manufacturing Laminated Body]

The method of manufacturing the laminated body according to the second embodiment of the present invention has a fifth process of applying the secondary particles obtained in the first process to at least one of the main surfaces of the resin substrate before the second process, in addition to the method of manufacturing the laminated body of the first embodiment described above. That is, the method of manufacturing the laminated body according to the second embodiment of the present invention is the method of manufacturing the laminated body of the second embodiment described above, having a first process of coagulating primary particles from an organic material and fabricating secondary particles, a fifth process of applying the secondary particles obtained in the first process to at least one of main surfaces of a resin substrate, a second process of disposing the resin substrate on which the secondary particles are disposed between adjacent electrode groups, a third process of applying a pressure to the electrode group in a thickness direction of the electrode group, separating the secondary particles into the primary particles, and filling a gap between the adjacent electrode groups with the primary particles, and a fourth process of deforming the primary particles between the adjacent electrode groups by the pressure and absorbing stress generated in the electrode group.

The method of manufacturing the laminated body of the embodiment will be described with reference to FIG. 11 to FIG. 14.

### (First Process)

The first process is the same as in the method of manufacturing the laminated body of the first embodiment described above.

### (Fifth Process)

In the fifth process, the secondary particles 20 obtained in the first process are applied to at least one of the one main surface 100a and the other main surface 100b of the resin substrate 100. The method of applying the secondary particles 20 to at least one of the one main surface 100a and the other main surface 100b of the resin substrate 100 may include, for example, a method of applying slurry containing the secondary particles 20 to at least one of the one main surface 100a and the other main surface 100b of the resin substrate 100, a method of spraying the secondary particles 20 to at least one of the one main surface 100a and the other main surface 100b of the resin substrate 100, or the like.

### (Second Process)

In the second process, as shown in FIG. 11, the plurality of electrode groups 10 are laminated, and for example, the resin substrate 100, with the secondary particles 20 disposed on both the main surfaces 100a and 100b, is disposed between the two adjacent electrode groups 10.

### (Third Process)

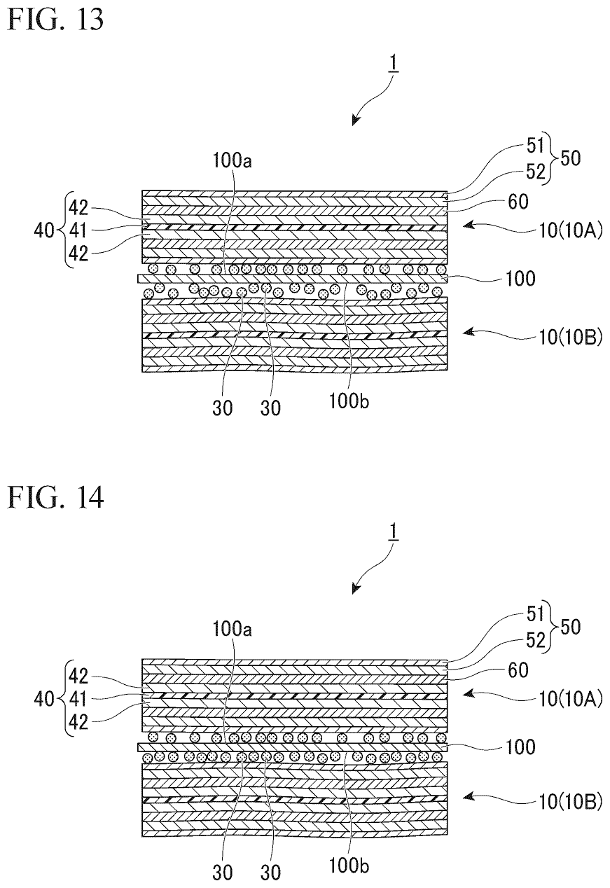

In the third process, as shown in FIG. 12 and FIG. 13, the pressure is applied to the plurality of electrode groups 10 in the thickness direction of the electrode group 10, the secondary particles 20 are separated into the primary particles 30, and the gap between the two adjacent electrode groups 10 is filled with the primary particles 30. When the pressure is applied to the plurality of electrode groups 10 in the thickness direction of the electrode group 10, as shown in FIG. 12 and FIG. 13, the secondary particles 20 subjected to the pressure are separated (collapsed) into the primary particles 30, the gap between the two adjacent electrode groups 10 are filled with the separated primary particles 30, and then the primary particles 30 are dispersed between the two adjacent electrode groups 10. Accordingly, the geometric tolerance of the two adjacent electrode groups 10 is absorbed by the primary particles 30.

### (Fourth Process)

In the fourth process, as shown in FIG. 14, further, the pressure is applied to the plurality of electrode groups 10 in the thickness direction of the electrode group 10 to deform the primary particles 30 between the two adjacent electrode groups 10, and the stress generated in the electrode group 10 is absorbed.

The fourth process includes applying further the pressure (external force) in the thickness direction of the laminated body 1 when the laminated body 1 is accommodated in exterior material, applying further the pressure (external force) in the thickness direction of the laminated body 1 when the laminated body accommodated in the exterior material is further assembled into a battery module, or expanding or contracting the laminated body 1 by charge/discharge. Accordingly, the primary particles 30 undergo super-elastic deformation, and the primary particles 30 absorb the pressure, making the pressure across the entire laminated body 1 almost uniform.

According to the method of manufacturing the laminated body of the embodiment, the laminated body 1 of the second embodiment described above is obtained.

### [Battery]

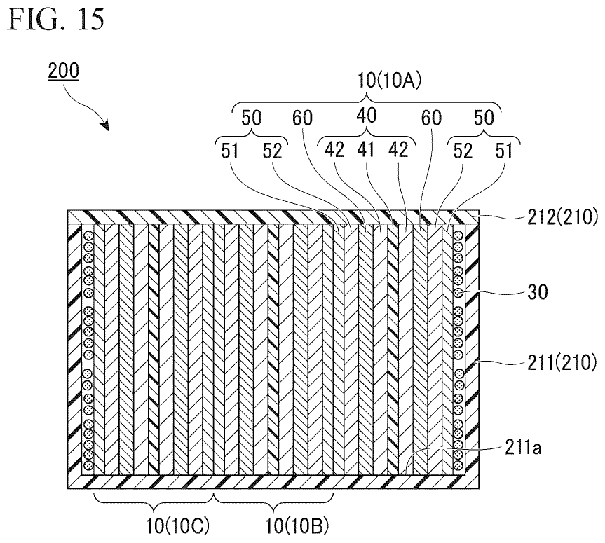

FIG. 15 is a cross-sectional view showing a battery according to an embodiment of the present invention.

As shown in FIG. 15, a battery 200 of the embodiment includes the laminated body 1 of the first or second embodiment described above, an exterior material 210, and beads 220.

The exterior material 210 is a member that covers the laminated body 1 and accommodates the laminated body 1 and the beads 220. In the embodiment, the exterior material 210 has a tubular main body 211 having a bottom surface 211a, and a lid body 212 configured to cover an opening portion of the main body 211.

The beads 220 are disposed in the exterior material 210 between the outermost layer of the laminated body 1 and the exterior material 210. The beads 220 are constituted by the primary particles 30 described above.

The exterior material 210 is not particularly limited as long as it is a material generally used for the exterior of the secondary battery, but examples include a metal can body, a laminate film, and the like.

The beads 220 are disposed primarily in the laminating direction of the electrode groups 10 in the laminated body 1, between the outermost layer of the laminated body 1 and the exterior material 210.

According to the battery 200 of the embodiment, by disposing the primary particles 30 between the outermost layer of the laminated body 1 and the exterior material 210, the dimensional tolerance and the geometric tolerance of the electrode group 10 can be absorbed by the primary particles 30, and damage to the laminated body 1 can be suppressed.

### (Method of Manufacturing Battery)

A method of manufacturing a battery according to an embodiment of the present invention has a process of accommodating the laminated body obtained by the method of manufacturing the laminated body of the above-mentioned embodiment in an exterior material (hereinafter, referred to as “a process A”), a process of disposing the secondary particles between the outermost layer of the laminated body and the exterior material (hereinafter, referred to as “a process B”), a process of applying a pressure to the secondary particles between the outermost layer of the laminated body and the exterior material in a thickness direction of the laminated body, separating the secondary particles into the primary particles, and filling a gap between the outermost layer of the laminated body and the exterior material with the primary particles (hereinafter, referred to as “a process C”), and a process of sealing the exterior material (hereinafter, referred to as “a process D”).

The method of manufacturing the battery of the embodiment will be described with reference to FIG. 15.

### (Process A)

In the process A, the laminated body 1 is accommodated in the exterior material 210.

### (Process B)

In the process B, the secondary particles are disposed between the outermost layer of the laminated body 1 and the exterior material 210.

As the method of disposing the secondary particles between the outermost layer of the laminated body 1 and the exterior material 210, for example, a method of filling a space between the outermost layer of the laminated body 1 and the exterior material 210 with secondary particles in powder, or the like, can be used.

### (Process C)

In the process C, the pressure is applied to the secondary particles between the outermost layer of the laminated body 1 and the exterior material 210 in the thickness direction of the laminated body 1, the secondary particles are separated into the primary particles 30, and the gap between the outermost layer of the laminated body 1 and the exterior material 210 is filled with the primary particles 30.

As the method of applying the pressure to the secondary particles between the outermost layer of the laminated body 1 and the exterior material 210 in the thickness direction of the laminated body 1, the gap can be filled with the primary particles 30 by applying the pressure to the exterior material 210 via a plate in a state in which the laminated body 1 is accommodated in the exterior material 210.

### (Process D)

In the process D, the exterior material 210 is sealed.

When the exterior material 210 has the main body 211 and the lid body 212 as shown in FIG. 15, the main body 211 is sealed with the lid body 212. When the exterior material 210 is a laminate film, the opening portion of the exterior material 210 is welded to seal the main body 211.

The battery 200 is obtained by the above-mentioned processes.

Although the embodiments of the present invention have been described in detail above, the present invention is not limited to the above-mentioned embodiments, and various modifications and changes may be made without departing the scope of the present invention described in the claims.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A laminated body obtained by laminating a plurality of electrode groups each including a positive electrode, a negative electrode and an electrolyte layer,
wherein secondary particles obtained by coagulating primary particles formed of an organic material are disposed between the electrode groups adjacent to each other, and
when a pressure is applied to the electrode group in a thickness direction of the electrode group, the secondary particles subjected to the pressure are separated into the primary particles, and a gap between the adjacent electrode groups is filled with the primary particles.

2. The laminated body according to claim 1, wherein an average particle diameter of the secondary particles is 50 μm or more and 2000 μm or less, and an average particle diameter of the primary particles is 0.05 μm or more and 100 μm or less.

3. The laminated body according to claim 1, wherein the primary particles are formed of at least one selected from acrylic resin, styrene resin, urethane resin, silicone resin, melamine resin and silicone-acrylic resin.

4. The laminated body according to claim 1, wherein the primary particles are covered with a metal material containing at least one selected from nickel, tin, gold, silver and platinum.

5. The laminated body according to claim 4, wherein a thickness of a covering of the metal material is 1 μm or less.

6. The laminated body according to claim 1, wherein the secondary particles contain at least one selected from an emulsion type, a micelle type and a gemini type.

7. The laminated body according to claim 1, wherein the secondary particles include a binder, and
the binder includes at least one selected from vinyl chloride resin, vinyl acetate resin, acrylic resin, silicone resin, ether resin, styrene resin, cyclohexane, toluene, and a compound having a dicarbonyl group having two hydrocarbon chains.

8. The laminated body according to claim 1, wherein the secondary particles have an internal space formed by coagulation of the primary particles, and
the internal space contains a liquid.

9. The laminated body according to claim 8, wherein the liquid contains at least one of cyclohexane and toluene.

10. The laminated body according to claim 1, further comprising a resin substrate with the secondary particles disposed on at least one main surface thereof,
wherein the resin substrate is disposed between the adjacent electrode groups.

11. The laminated body according to claim 1, wherein the electrolyte layer is a solid electrolyte layer.

12. A battery comprising the laminated body according to claim 1, an exterior material that covers the laminated body, and beads disposed between the outermost layer of the laminated body and the exterior material,
wherein the beads are constituted by the primary particles.

13. A method of manufacturing a laminated body obtained by laminating a plurality of electrode groups each including a positive electrode, a negative electrode and an electrolyte layer, the method having:
a first process of coagulating primary particles formed of an organic material and fabricating secondary particles;
a second process of disposing the secondary particles between the electrode groups adjacent to each other;
a third process of applying a pressure to the electrode group in a thickness direction of the electrode group, separating the secondary particles into the primary particles, and filling a gap between the adjacent electrode groups with the primary particles; and
a fourth process of deforming the primary particles between the adjacent electrode groups by the pressure and absorbing stress generated in the electrode group.

14. The method of manufacturing a laminated body according to claim 13, further including a fifth process of applying the secondary particles obtained in the first process to at least one main surface of a resin substrate, before the second process.
